(19) United States
(12) Patent Application Publication
(10) Pub. No.: US 2005/0213915 A1
(43) Pub. Date: Sep. 29, 2005

(54) Method of manufacturing optical waveguide device

(75) Inventors: Chie Fukuda, Yokohama-shi (JP); Tetsuya Hattori, Yokohama-shi (JP); Morihiro Seki, Yokohama-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/087,545

(22) Filed: Mar. 24, 2005

(30) Foreign Application Priority Data
Mar. 26, 2004 (JP) 2004-092828

(51) Int. Cl. G02B 6/10

(52) U.S. Cl. 385/129

(57) ABSTRACT

In a method of manufacturing an optical waveguide device, the surface of a core can be planarized in a concaving process. In this manufacturing method, a plasma CVD apparatus having a coil for producing plasma and a table for mounting products is used. In the method, a first cladding having a concavity is mounted on the table, a core film is formed on the first cladding while high-frequency electric power P₁ is supplied to the coil and high-frequency electric power P₂ is supplied to the table, a resist film is formed on the core film, a core is formed in the concavity by etching the resist film and the core film, and a second cladding is formed on the first cladding and the core.

### BACKGROUND OF THE INVENTION

1. Field of the Invention

The present invention relates to a method of manufacturing an optical waveguide device.

2. Description of the Background Arts

One example of a method of manufacturing an optical waveguide device is a concaving process, as described in Japanese Patent Application Publications Nos. 6-331844 and No. 2003-161852. In the concaving process in Japanese Patent Application Publication No. 6-331844, (1) a groove pattern is formed on an undercladding, (2) a core film is formed within the groove pattern and on the undercladding using flame hydrolysis deposition (FHD) method, (3) a resist film is formed on the core film, (4) the resist film and the core film on the undercladding are removed by reactive ion etching (RIE) such that the core film remaining in the groove pattern of the undercladding becomes a core, and (5) an overcladding is formed on the core and the undercladding, resulting in an optical waveguide device.

Japanese Patent Application Publication No. 2003-161852 describes a concaving process that uses liftoff technology. In this concaving process, (1′) a mask is formed on a glass substrate, (1″) an undercladding with a groove is formed by etching portions of the substrate exposed from the mask by RIE to form a groove in the substrate, (2′) a core film is formed in the groove and on the undercladding using plasma CVD without removing the mask, (4′) a core is formed in the groove of the undercladding by removing the mask and the core film formed on the mask by wet etching, and (5) an overcladding is formed on the core and the undercladding, resulting in an optical waveguide device.

However, in the concaving process using the FHD method, the surface of the resulting core is not planarized, as will be described hereinbelow. A method of manufacturing an optical waveguide device using the FHD method is herein described with reference to FIGS. 4A to 4C. FIGS. 4A to 4C are cross-sectional views showing an optical waveguide device being manufactured in each step of a method of manufacturing an optical waveguide device using the FHD method.

First, a core film 114a is formed using the FHD method on a first cladding 112 having a groove 112b so as to fill in the groove 112b, as shown in FIG. 4A. The core film 114a is obtained by depositing microparticles of SiO₂ in the groove 112b, and consolidating at a high temperature of 1000° C. or greater. The core film 114a has a channel 114b corresponding to the groove 112b of the first cladding 112. The channel 114b has a relatively wide width w103 and a deep depth d103. For example, the width w103 of the channel 114b is greater than the width w101 of the groove 112b.

Next, a resist film 116a is formed on the core film 114a so as to fill in the channel 114b of the core film 114a, as shown in FIG. 4B. A channel 116b corresponding to the channel 114b of the core film 114a is remained in the surface of the resist film 116a thus obtained.

Next, a core 114 is formed in the groove 112b of the first cladding 112 by etching the resist film 116a and the core film 114a, as shown in FIG. 4C. A channel 114c corresponding to the channel 116b of the resist film 116a is inevitably remained on the surface of the core 114. Therefore, the surface of the resulting core 114 cannot be planarized when the core film 114a is formed using the FHD method.

### SUMMARY OF THE INVENTION

An object of the present invention is to provide a method of manufacturing an optical waveguide device wherein the surface of the core can be planarized in a concaving process.

In order to achieve the objective, a method of manufacturing an optical waveguide device having a first cladding, a core, and a second cladding, includes the steps of: with a plasma CVD apparatus having a coil for producing plasma and a table for mounting products, mounting on the table a first cladding that has a concavity; forming a core film on the first cladding while supplying high-frequency electric power P₁ to the coil and supplying high-frequency electric power P₂ to the table; forming a resist film on the core film; forming a core in the concavity by etching the resist film and the core film; and forming a second cladding on the first cladding and the core.

Advantages of the present invention will become apparent from the following detailed description, which illustrates the best mode contemplated to carry out the invention. The invention is capable of other and different embodiments, the details of which are capable of modifications in various obvious respects, all without departing from the invention. Accordingly, the accompanying drawing and description are illustrative in nature, not restrictive.

### BRIEF DESCRIPTION OF THE DRAWINGS

The present invention is illustrated by way of example, and not by way of limitation, in the figures of the accompanying drawing in which like reference numerals refer to similar elements.

FIGS. 1A to 1F are cross-sectional views showing an optical waveguide device being manufactured in each step in an embodiment of the method of manufacturing an optical waveguide device of the present invention;

FIG. 2 is a cross-sectional view showing an optical waveguide device manufactured by the method of manufacturing an optical waveguide device of the present invention;

FIG. 3 is a schematic view showing an example of a plasma CVD apparatus used in the method of manufacturing an optical waveguide device of the present invention; and

FIGS. 4A to 4D are cross-sectional views showing an optical waveguide device being manufactured in each step of a method of manufacturing an optical waveguide device using FHD.

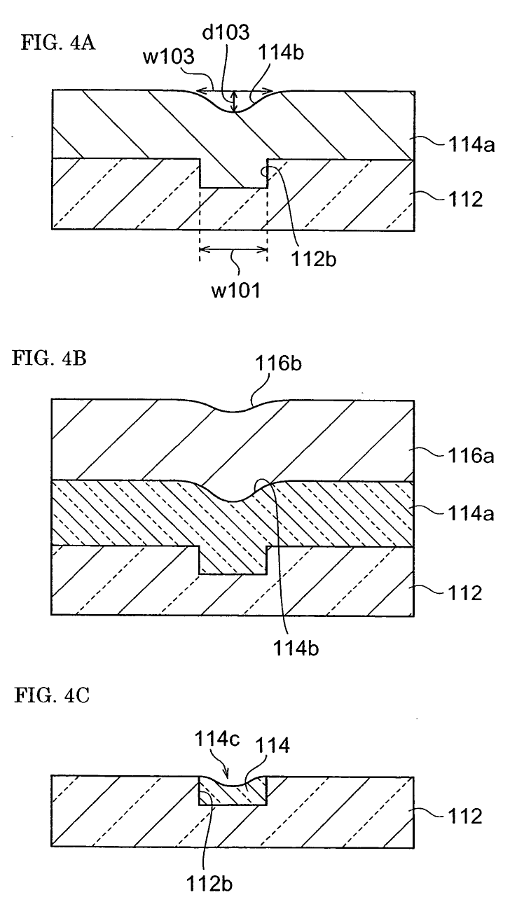

### DESCRIPTION OF THE PREFERRED EMBODIMENTS

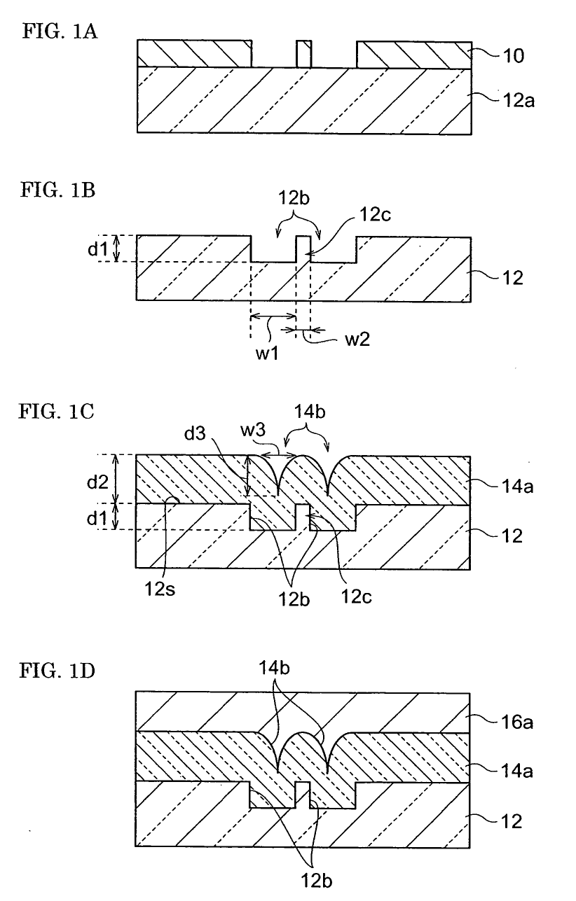

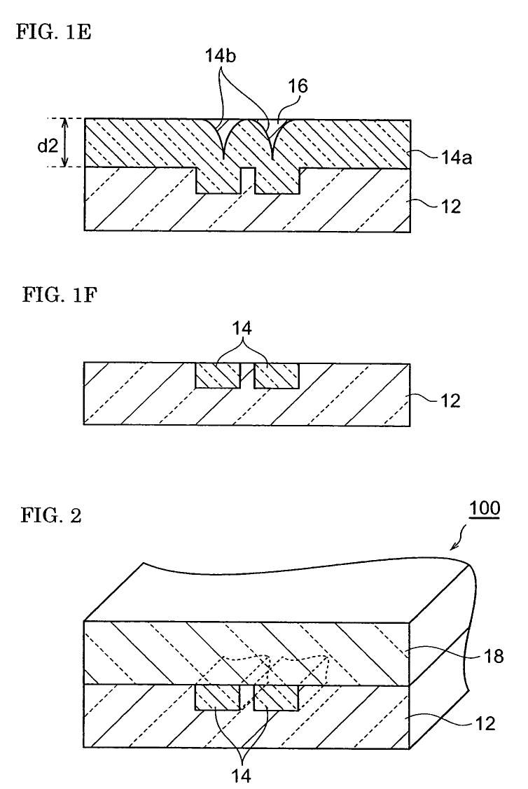

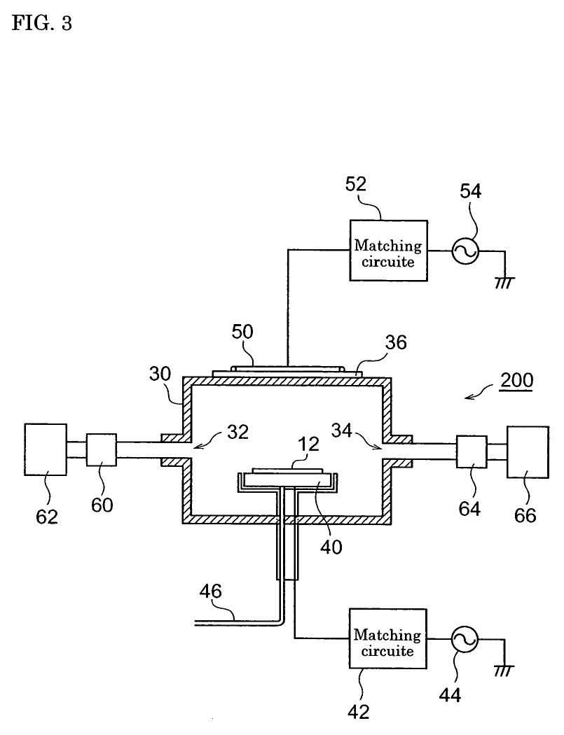

First, an embodiment of the method of manufacturing an optical waveguide device 100 of the present invention will be described with reference to FIGS. 1A through 1F, FIG. 2, and FIG. 3. FIGS. 1A to 1F are cross-sectional views showing an optical waveguide device being manufactured in each step of the method of manufacturing an optical waveguide device according to an embodiment of the present invention. FIG. 2 is a cross-sectional view showing an optical waveguide device manufactured by the method of manufacturing an optical waveguide device of the present invention. FIG. 3 is a schematic view showing an example of a plasma CVD apparatus used in the method of manufacturing an optical wave guide device of the present invention.

(Mask Formation Step)

A patterned mask 10 is formed on a substrate 12a as shown in FIG. 1A. The substrate 12a is made of silica glass, for example. The mask 10 is made of a resist, metal, for example, and is formed using photolithography.

(First Cladding Formation Step)

A first cladding 12 having grooves 12b (concavity) is obtained by etching the substrate 12a using the mask 10, as shown in FIG. 1B. The first cladding 12 functions as an undercladding. The grooves 12b extend in a direction corresponding to the pattern of the mask 10. The aspect ratio R1 (depth d1/width w1) of each of the grooves 12b is 0.4 to 1.5, for example. In an exemplifying example, the width w1 is 8 μm, the depth d1 is 8 μm, and the aspect ratio R1 is 1. Alternatively, the width w1 can be 15 μm, the depth d1 can be 6.5 μm, and the aspect ratio R1 can be 0.433. Still alternatively, the width w1 can be 4.5 μm, the depth d1 can be 6.5 μm, and the aspect ratio R1 can be 1.44.

Also, when the first cladding 12 has a plurality of grooves 12b as shown in FIG. 1B, a partitioning section 12c is formed between adjacent grooves 12b. The aspect ratio R2 (height d1/width w2) of the partitioning section 12c is 1 to 8, for example. In an exemplifying example, the width w2 is 1 μm, the height d1 is 8 μm, and the aspect ratio R2 is 8. Alternatively, the width w2 can be 6.5 μm, the height d1 can be 6.5 μm, and the aspect ratio R2 can be 1.

RIE is preferred as the method of etching. C₂F₆ is preferably used as the etching gas for RIE. CF₄, CHF₃, C₄F₈, or the like can also be used instead of C₂F₆. After etching with these gases, it is possible to perform RIE with oxygen gas, and acid cleaning or the like. The residue such as the resist or the like remaining on the first cladding 12 can thereby be removed.

(Core Film Formation Step)

A core film 14a is formed on the first cladding 12 so as to fill in the grooves 12b of the first cladding 12, as shown in FIG. 1C. The core film 14a is formed using the plasma CVD apparatus 200 shown in FIG. 3.

Referring to FIG. 3, the plasma CVD apparatus 200 includes a chamber 30, and a susceptor (table) 40 for supporting the first cladding 12 provided inside the chamber 30. The chamber 30 has a supply port 32 for supplying the process gas, and an exhaust port 34 for expelling the process gas. A gas supply device 62 is connected to the supply port 32 via a mass flow controller (MFC) 60 for controlling the gas flow rate. A vacuum pump 66 is connected to the exhaust port 34 via an exhaust adjustment valve 64 for adjusting the exhaust conductance.

The chamber 30 has a window 36 disposed facing the susceptor 40. The window 36 is designed to allow a high-frequency electromagnetic field to enter the chamber 30. A coil 50 provided to the exterior of the chamber 30 generates the high-frequency electromagnetic field.

A high-frequency power source 44 is connected to the susceptor 40 via a matching circuit 42. High-frequency electric power with a frequency of several hundred kilohertz to several megahertz and an output power of several dozen watts to several hundred watts can be supplied to the susceptor 40 by the high-frequency power source 44. Furthermore, the impedance is matched between the high-frequency power source 44 and the susceptor 40 by the matching circuit 42, and the power output can be efficiently supplied to the susceptor 40.

A pipe 46 for circulating cooling water to the susceptor 40 is connected to the susceptor 40. The cooling water can be circulated through the interior or periphery of the susceptor 40. Temperature increases in the susceptor 40 resulting from the high-frequency electric power supplied from the high-frequency power source 44 can thereby be suppressed.

Also, inductively coupled plasma (ICP) is produced in the chamber 30 by the coil 50. A high-frequency power source 54 is connected to the coil 50 via a matching circuit 52. High-frequency electric power with a frequency of several dozen megahertz and an output of several hundred watts to several thousand watts can be supplied to the coil 50 by the high-frequency power source 54. Furthermore, the impedance is matched between the high-frequency power source 54 and the coil 50 by the matching circuit 52, and the power output can be efficiently supplied to the coil 50.

The core film 14a is formed as follows using the plasma CVD apparatus 200 described above. The following description refers to FIG. 1C and FIG. 3.

First, the first cladding 12 is placed on the susceptor 40. Process gas is then supplied from the supply port 32 into the chamber 30. Then, plasma is produced in the chamber 30 by the supply of high-frequency electric power to the coil 50. At this time, the core film 14a is formed on the first cladding 12 while the high-frequency electric power is supplied to the susceptor 40.

Examples of process gas include oxygen gas, a gas composed of an organosilicon compound, and a gas composed of an organogermanium compound. Possible examples of the organosilicon compound include tetramethoxysilane (TMOS). Possible examples of the organogermamium compound include tetramethyl germanium (TMGe) and tetramethoxygermanium (TMOGe). In TMOS and TMGe, the numbers of moles of carbon atoms, hydrogen atoms, and oxygen atoms in the organic groups are fewer than those in other organic metallic compounds. Therefore, it is possible to prevent impurities from remaining in the resulting core film 14a. As a result, the optical loss of the resulting optical waveguide device 100 can be reduced.

The electron density of the plasma produced in the chamber 30 is preferably 1×10¹⁰ cm⁻³ or greater. The density of the core film 14a formed in the grooves 12b can thereby be improved, and the rate at which the core film 14a is formed can be increased. Furthermore, it is also possible to prevent voids from remaining in the grooves 12b.

Also, the electron density uniformity of the plasma is preferably such that the deviation is kept at ±5% or less within a diameter range of 200 mm in a direction parallel to the surface 12s of the first cladding 12. The uniformity of the surface of the core film 14a formed on the first cladding 12 is thereby improved. In an exemplifying example, the thickness d2 of the core film 14a is 12 μm when the diameter of the circular first cladding 12 is 150 mm and the depth d1 of the grooves 12b is 8 μm.

The core film 14a formed as described above has channels 14b corresponding to the grooves 12b of the first cladding 12. Each of the channels 14b has a V shape, and the width w3 thereof is smaller than the width w1 of the groove 12b in the first cladding 12. The aspect ratio R3 (depth d3/width w3) of the channels 14b is preferably 0.4 to 1.65, and is more preferably 0.45 to 1.6. Also, the bottoms of the channels 14b are positioned above the surface 12s of the first cladding 12. Therefore, the depth d3 of the channels 14b is smaller than the film thickness d2 of the core film 14a. In an exemplifying example, the width w3 is 14 μm, the depth d3 is 6.5 μm, and the aspect ratio R3 is 0.464. Alternatively, the width w3 can be 4.0 μm, the depth d3 can be 6.5 μm, and the aspect ratio R3 can be 1.625.

(Resist Film Formation Step)

Next, a resist film 16a that fills in the channels 14b of the core film 14a is formed on the core film 14a, as shown in FIG. 1D. The resist film 16a is preferably formed after the core film 14a is formed, without using the step of heat-treating the core film 14a. The thickness of the resist film 16a is preferably 5 to 10 μm. In an exemplifying example, spin coating is used to coat the core film 14a with a thick film resist at a rotational frequency of 3000 rpm. A resist film 16a with a thickness of 6 μm is then obtained by performing baking at a temperature of 100° C. or greater.

No substantial channels are remained in the surface of the resist film 16a thus obtained. This is due to the shape of the channels 14b on the core film 14a. As used herein, the term “no substantial channels are remained” refers to a case in which any concavities or convexities remained on the surface of the resist film 16a has the depth or height of 0.2 μm or less.

(Core Forming Step)

Next, the resist film 16a is etched (etch-backed) until the core film 14a is exposed, as shown in FIG. 1E. Specifically, for example, oxygen gas is used to dry etch the resist film 16a. The resist film 16a is thereby removed except for the part within the channels 14b, and a resist 16 remains.

Next, a core 14 is formed from the core film 14a by etching (etch-backing) the core film 14a and the resist 16, as shown in FIG. 1F. The core 14 is formed in the grooves 12b of the first cladding 12. Specifically, the core film 14a and the resist 16 are dry-etched using a mixed gas composed of oxygen gas and C₂F₆, for example.

In an exemplifying example, the ratio of the flow rates of oxygen gas and C₂F₆ is 14:100. At this ratio, the core film 14a and the resist 16 can be etched at an equal etching rate. When the thickness d2 of the core film 14a is 12 μm, for example, the etching depth is 12 μm.

Also, the etching condition may be changed in the step of etching the resist film 16a and the step of etching the core film 14a and resist 16. Examples of an etching condition include the etching bias.

(Heat Treatment Step)

Next, it is preferable to anneal the first cladding 12, in which the core 14 is formed in the grooves 12b, in an atmosphere of oxygen. Specifically, the heat treatment temperature is preferably 1000° C., and the heat treatment time is preferably 10 hours. The heat treatment makes it possible to remove the impurities mixed in the core 14.

(Second Cladding Formation Step)

Next, a second cladding 18 is formed on the first cladding 12 and the core 14 as shown in FIG. 2. The second cladding 18 functions as an overcladding. The second cladding 18 is preferably made of silica glass, and is preferably formed using plasma CVD, for example.

(Heat Treatment Step)

Next, the second cladding 18 is preferably annealed in an atmosphere of oxygen. Specifically, the heat treatment temperature is preferably 1000° C., and the heat treatment time is preferably 10 hours. The heat treatment makes it possible to remove the impurities mixed in the second cladding 18.

An optical waveguide device 100 is obtained by performing the steps described above. In the optical waveguide device 100, light is trapped in the core 14 because the refractive indexes of the first cladding 12 and the second cladding 18 are both less than the refractive index of the core 14. The core 14 extends in a specific direction. The optical waveguide device 100 may be a planar waveguide splitter, for example. In this case, in an exemplifying example, the optical loss of the optical waveguide device 100 is 0.1 dB/cm or less, and the polarization dependence loss is 0.05 dB or less.

As described above, in the method of manufacturing the optical waveguide device 100 relating to the present embodiment, the core film 14a is formed while high-frequency electric power is supplied to a susceptor 40 that supports the first cladding 12 using the plasma CVD apparatus 200. As a result, the width w3 of the channels 14b remained in the surface of the core film 14a is less than the width w1 of the grooves 12b in the first cladding 12. When the resist film 16a is formed on the core film 14a in which the channels 14b is remained, no substantial channels corresponding to the grooves 12b in the first cladding 12 are remained on the surface of the resist film 16a. Therefore, no substantial channels are remained on the surface of the core 14 obtained by etching. Consequently, according to the present embodiment, an optical waveguide device 100 is obtained in which the surface of the core 14 is planarized during the concaving process.

Also, since the core film 14a is formed using plasma the CVD method, more preferable film properties are obtained than those of a core film formed using other methods such as FHD. Furthermore, using the common plasma CVD method disclosed in Japanese Patent Application Publication No. H8-133785 creates a tendency that voids are remained in the core film at the groove of the first cladding. However, if the plasma CVD method that supplies high-frequency electric power to both the coil and the table as described above is used, the occurrence of such voids can be prevented. Furthermore, a satisfactory core film 14a is formed even when the aspect ratio R1 of the grooves 12b and the aspect ratio R2 of the partitioning section 12c are high.

Also, the frequency of the high-frequency electric power P₁ supplied to the coil 50 in the core film formation step is preferably 1 to 20 MHz. Furthermore, the power output of the high-frequency electric power P₁ is preferably 500 to 2000 W. The frequency of the high-frequency electric power P₂ supplied to the susceptor 40 is preferably 100 kHz to 1 MHz. Furthermore, the power output of the high-frequency electric power P₂ is preferably 100 to 1000 W.

Furthermore, in the step for forming the core film, the ratio between the high-frequency electric power P₁ supplied to the coil 50 for producing plasma, and the high-frequency electric power P₂ supplied to the susceptor (table) 40 (P₂/P₁) is preferably 0.1 to 0.8. In such a case, the channels 14b having a more preferable shape is remained on the surface of the core film 14a shown in FIG. 1C. Specifically, the width w3 of the channels 14b becomes smaller than the width w1 of the grooves 12b in the first cladding 12, for example. Therefore, no substantial channels are remained on the surface of the resist film 16a shown in FIG. 1D. As a result, the surface of the core 14 shown in FIG. 1F can be further planarized. In an exemplifying example, the high-frequency electric power P₁ is 1100 W and the high-frequency electric power P₂ is 150 W. The ratio (P₂/P₁) in this case is 0.14. When the high-frequency electric power P₁ is 1100 W and the high-frequency electric power P₂ is 500 W, the ratio (P₂/P₁) is 0.45. When the high-frequency electric power P₁ is 1000 W and the high-frequency electric power P₂ is 800 W, the ratio (P₂/P₁) is 0.8.

Also, in the core film formation step, the thickness d2 of the core film 14a on the surface 12s of the first cladding 12 is preferably equal to or smaller than twice the depth d1 of the concavity (groove) 12b of the first cladding 12. The thickness of the core film 14a thereby becomes smaller as compared to the case where a core film is formed using the FHD; therefore, the amount of the core film to be removed when the core 14 is formed can be reduced. Also, the thickness d2 of the core film 14a is preferably equal to or greater than 1.1 times the depth d1 of the groove 12b in the first cladding 12.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2004-092828 filed on Mar. 26, 2004 including specification, claims, drawings, and summary are incorporated herein by reference in its entirety.

1. A method of manufacturing an optical waveguide device having a first cladding, a core, and a second cladding, comprising the steps of:
with a plasma CVD apparatus having a coil for producing plasma and a table for mounting products, mounting on the table a first cladding that has a concavity;
forming a core film on the first cladding while supplying high-frequency electric power P₁ to the coil and supplying high-frequency electric power P₂ to the table;
forming a resist film on the core film;
forming a core in the concavity by etching the resist film and the core film; and
forming a second cladding on the first cladding and the core.

2. A method of manufacturing an optical waveguide device according to claim 1, wherein
in the step of forming the core film, a ratio between the high-frequency electric power P₁ and the high-frequency electric power P₂ (P₂/P₁) is 0.1 to 0.8.

3. A method of manufacturing an optical waveguide device according to claim 1, wherein
in the step of forming the core film, the thickness of the core film is equal to or less than twice the depth of the concavity.

4. A method of manufacturing an optical waveguide device according to claim 2, wherein
in the step of forming the core film, the thickness of the core film is equal to or less than twice the depth of the concavity.
